(19) United States
(12) Patent Application Publication
(10) Pub. No.: US 2008/0223038 A1
(43) Pub. Date: Sep. 18, 2008

(54) Arrangement for Recirculating and Cooling Exhaust Gas of an Internal Combustion Engine

(75) Inventors: Rainer Lutz, Steinheim (DE); Rolf Muller, Ludwigsburg (DE); Jens Ruckwied, Stuttgart (DE); Christian Saumweber, Stuttgart (DE)

Correspondence Address: FOLEY AND LARDNER LLP;SUITE 500, 3000 K STREET NW, WASHINGTON, DC, 20007, US

(73) Assignee: BEHR GmbH & Co. KG, Stuttgart (DE)

(21) Appl. No.: 12/089,402

(22) PCT Filed: Oct. 6, 2006
(86) PCT No.: PCT/EP06/09667

§ 371 Date: Apr. 7, 2008

(30) Foreign Application Priority Data
Oct. 10, 2005 (DE) 10 2005 048 911.7

(51) Int. Cl. F02B 33/44

(52) U.S. Cl. 60/605.2; 60/320

(57) ABSTRACT

The invention relates to an arrangement for recirculating and cooling exhaust gas of an internal combustion engine (2), in particular of a diesel engine in a motor vehicle, wherein the internal combustion engine (2) has an exhaust line (3) with an exhaust gas turbine (6) and an intake line (4) with a charge air compressor (8) which is driven by the exhaust gas turbine (6), wherein an extraction point (11) for branching off an exhaust gas recirculation line (EGR line 5) is arranged downstream of the turbine (6) and a recirculation point (12) for recirculating the EGR line (5) is arranged upstream of the compressor (8), and wherein at least one exhaust gas heat exchanger (13) and an EGR valve (14) are arranged in the EGR line (5). It is proposed according to the invention that a charge air throttle element (17) is arranged in the intake line (4) and that the EGR valve (14), the recirculation point (12) and the throttle element (17) are formed as an integrated component (19).

The invention relates to an arrangement for recirculating and cooling exhaust gas of an internal combustion engine according to the preamble of claim 1.

Exhaust gas recirculation (abbreviation: EGR), in particular cooled exhaust gas recirculation, is used in present-day vehicles as a result of legislation, in order to lower emissions of particulates and pollutants, in particular nitrogen oxides. EGR systems are known in which the exhaust gas is extracted on the high-pressure side of an exhaust gas turbine or on the low-pressure side of the exhaust gas turbine, so that high-pressure or low-pressure exhaust gas recirculation is referred to. Known through DE 102 03 003 A1 of the applicant is a high-pressure EGR system in which the exhaust gas to be recirculated is extracted from the exhaust gas line between engine and exhaust gas turbine and is supplied to the intake tract of the engine. In this case the attainable exhaust gas recirculation rate depends on the differential pressure between the extraction point and the recirculation point in the EGR line, in which an EGR valve and an exhaust gas cooler are arranged.

Known through EP 0 916 837 B1 of the applicant is a device for an EGR system in which an EGR valve and an exhaust gas cooler are integrated to form a constructional unit. A further exhaust gas cooler with bypass and bypass valve for a high-pressure EGR system is known through EP 1 030 050 B1.

Known through EP 1 203 148 B1 is a low-pressure EGR system for an internal combustion engine, i.e. a diesel engine, in the exhaust gas duct of which there is arranged an exhaust gas turbine which drives a charge air compressor. Also arranged in the exhaust gas duct, downstream of the turbine, is a catalytic converter/filter unit, in the region of which exhaust gas is extracted, cooled by an exhaust gas cooler and supplied to the intake tract of the engine upstream of the compressor. Located in the EGR line downstream of the exhaust gas cooler is an EGR valve which controls the throughput in the EGR line. An advantage of the known low-pressure EGR system is that higher exhaust gas recirculation rates can be achieved than with the high-pressure system, since the recirculated exhaust gas is aspirated by the compressor. A disadvantage of the known EGR system is that each component must be manufactured and installed separately, increasing the cost of the EGR system.

Starting from a low-pressure EGR system, it is the object of the present invention to provide an arrangement for recirculating and cooling exhaust gas of the type mentioned in the introduction which simplifies the total system, lowers the manufacturing cost and increases the efficiency of the system.

This object is achieved by the features of claim 1. Advantageous configurations of the invention are apparent from the dependent claims.

According to the invention there is provided a first integration solution which comprises integration of the EGR valve, the EGR recirculation point and a charge air throttle element in the intake line of the engine. The constructional integration of these three components to form one part has the advantages that installation space is reduced, installation is simplified and cost and weight are lowered. The arrangement of the integrated part downstream of the exhaust gas cooler further has the advantage that thermal stress, especially during the regeneration phase of the particulate filter, is reduced. In addition, the dynamic behavior of the system is improved in that the control elements for fresh air and exhaust gas admixture are arranged directly upstream of the compressor. This also results in a shortening of the response time under changed load conditions in comparison to an arrangement upstream of the exhaust gas cooler. Finally, the inventive integration solution has the advantage that the total length of the lines in the EGR duct is reduced, leading to a reduction in pressure losses and an increase in the maximum possible EGR rates.

The part resulting from the integration of the components mentioned has two inlets, one on the exhaust gas side and one on the fresh air side, and an outlet to the compressor suction side. The exhaust gas-side inlet controls the exhaust gas recirculation rate, while the fresh air-side inlet throttles the charge air to be supplied to the compressor. It is important in this respect that a sufficient surge limit gap for the compressor is ensured by restriction of the throttling on the suction side. The latter is simpler to achieve with independent adjustability of both inlets, since control of the EGR recirculation rate is largely decoupled thereby. According to an advantageous configuration, therefore, the two alternatives are provided that, firstly, the inlets are independent of one another and, secondly, they are adjustable dependently of one another, which again reduces cost. It is advantageous with independent adjustability of the two inlets (throttle elements) that the control range of the total system is increased.

According to a further variant, it is provided that an air filter arranged in the intake line is additionally integrated in the part and thus becomes a constituent of a further integration solution. The benefits of the advantages previously mentioned, namely reduced installation space, simplified installation and reduced cost and weight, are thereby further exploited.

According to a further variant, it is provided that a condensate separator (for separating corrosive condensate arising from the exhaust gas cooling) arranged in the EGR line is also a constituent of the integration solution. A still greater degree of integration, amplifying the above-mentioned advantages, is thereby achieved. This integration solution with integrated condensate separator is possible with integrated air filter or without air filter.

In a further increase of the degree of integration, the exhaust gas cooler in the EGR line also becomes a constituent of an integration solution, so that a part consisting of exhaust gas cooler with a condensate separator, EGR valve, charge air throttle and/or air filter is made possible.

A further variant of the integration provides that the compressor can additionally be integrated with the first integration solution, in particular also with condensate separator and air filter.

Exemplary embodiments of the invention are represented in the drawing and are described in more detail below. In the drawings:

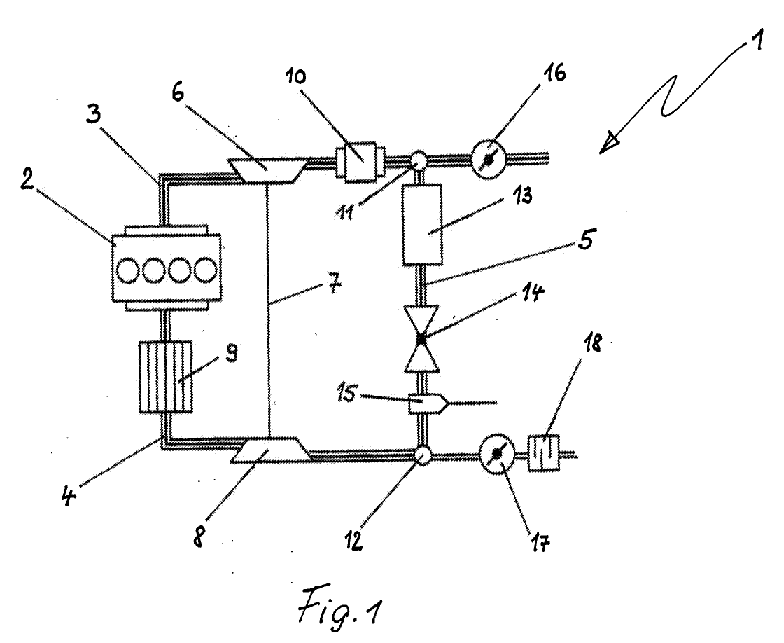

FIG. 1 shows a low-pressure EGR system (LP EGR system) with separate components;

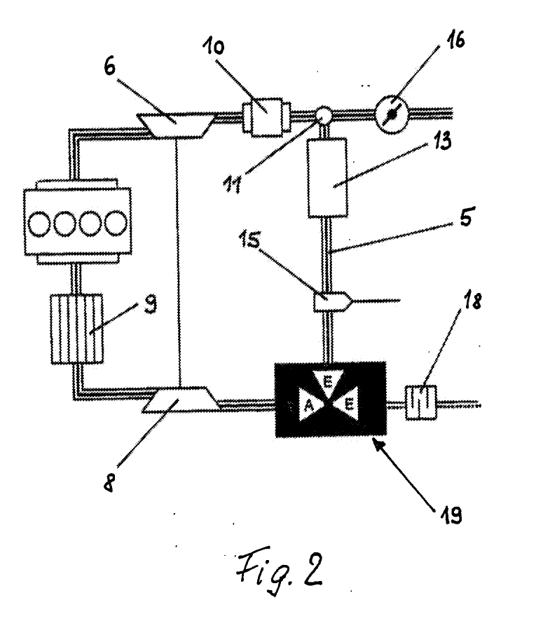

FIG. 2 shows the LP EGR system with a first integrated constructional unit;

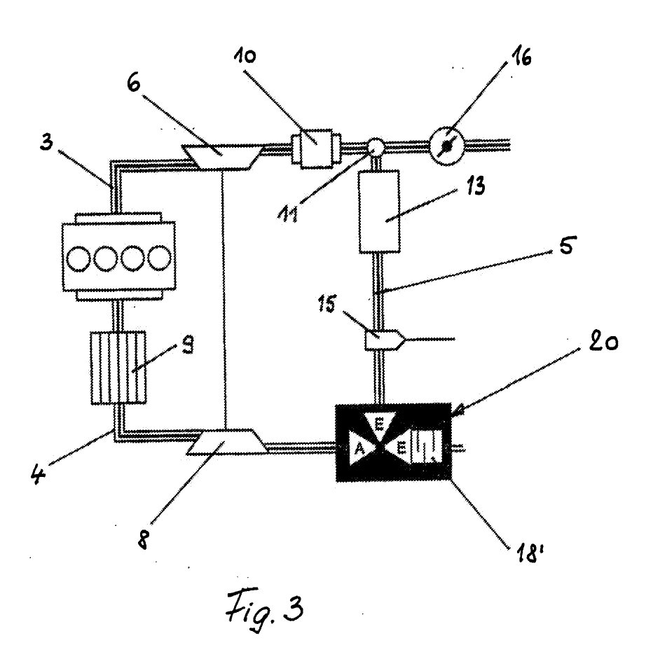

FIG. 3 shows the LP EGR system with a second integrated constructional unit;

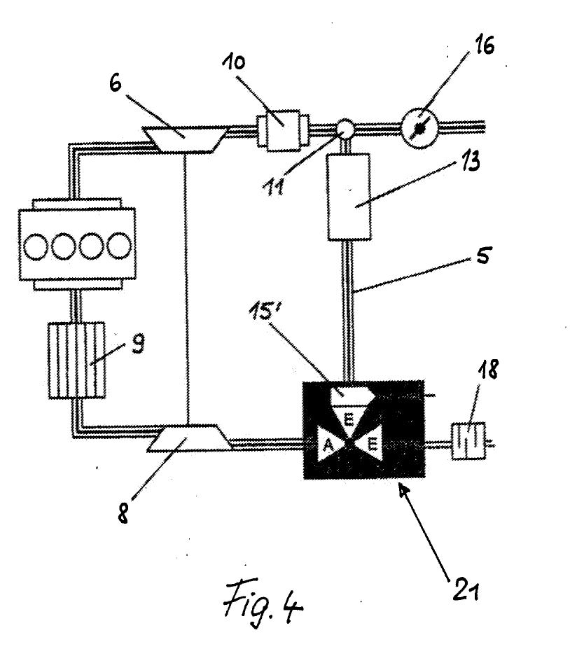

FIG. 4 shows the LP EGR system with a third integrated constructional unit;

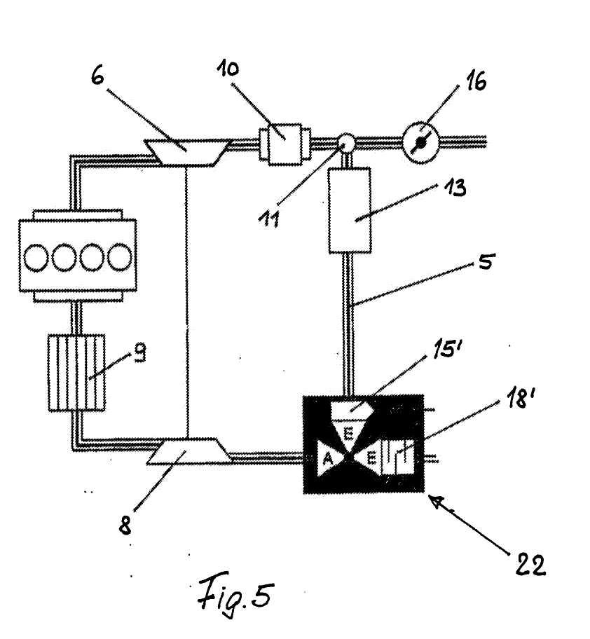

FIG. 5 shows the LP EGR system with a fourth integrated constructional unit;

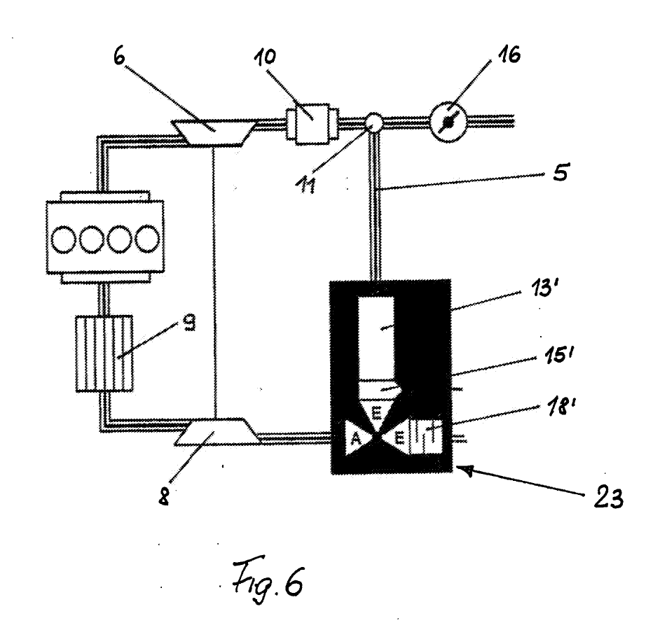

FIG. 6 shows the LP EGR system with a fifth integrated constructional unit, and

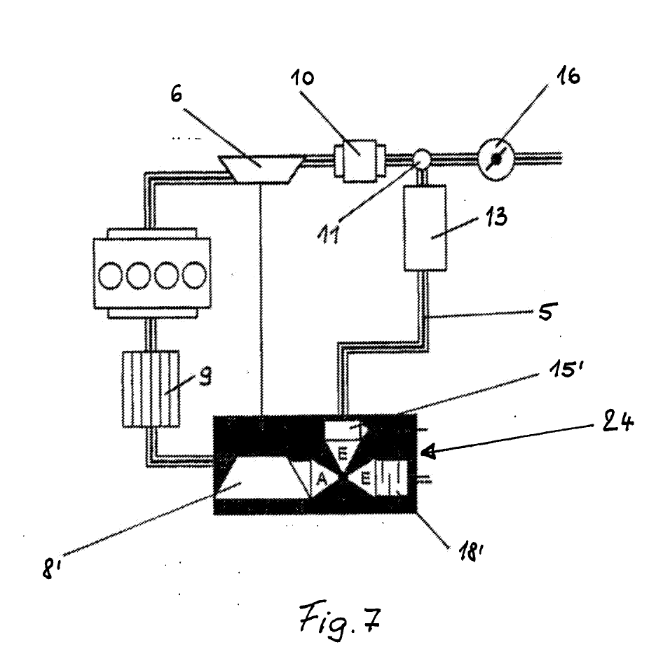

FIG. 7 shows the LP EGR system with a sixth integrated constructional unit.

FIG. 1 shows a low-pressure exhaust gas recirculation system, hereinafter abbreviated to LP EGR system 1, in a schematic representation. An internal combustion engine 2, preferably a diesel engine 2, has an exhaust gas line 3, an intake line 4 for combustion or charge air and an exhaust gas recirculation line, hereinafter called EGR line 5, arranged between exhaust gas line 3 and intake line 4. Arranged in the exhaust gas line 3 is an exhaust gas turbine 6 which drives a charge air compressor 8 arranged in the intake line 4 via a shaft 7. Turbine 6, shaft 7 and compressor 8 thus form an exhaust gas turbocharger unit. Arranged after the charge air compressor 8 in the flow direction is a charge air cooler 9, which cools the compressed and heated charge air before it is supplied to the internal combustion engine 2. A combined particulate filter and oxidation catalytic converter 10 is arranged after the turbine 6 in the exhaust gas flow direction. A branch or extraction point 11, from which the EGR line 5 branches, is arranged in the exhaust gas line 3 downstream of the oxidation catalytic converter 10. Analogously, a recirculation point 12, where the exhaust gas to be recirculated is fed into the intake line 4, is arranged in the intake line 4 on the suction side of the compressor 8. An exhaust gas cooler 13, an EGR valve 14 and a condensate separator 15 are provided in the EGR line 5. The exhaust gas cooler 13 may be air-cooled or water-cooled. The exhaust gas cooling may also take place in two stages in one or two exhaust gas coolers. The EGR valve 14 controls the exhaust gas recirculation rate via the flow-through cross section, while the condensate separator 15 captures and removes the corrosive condensate arising in the exhaust gas cooler 13. An exhaust gas back-pressure valve 16, via which the exhaust gas back-pressure in the exhaust gas line 8 can be adjusted, is arranged in the exhaust gas line 3 downstream of the extraction point 11. A charge air throttle 17 and an air filter 18 are arranged in the intake line 4 upstream of the recirculation point 12. It can be seen from the drawing that the exhaust gas recirculation, i.e. the extraction takes place on the low-pressure side of the turbine 6 and the recirculation on the suction side of the compressor 8. The invention starts from a low-pressure EGR system of this kind.

FIG. 2 shows the LP EGR system according to FIG. 1 in a first modified form, the same reference numerals being used for identical parts. In a deviation from FIG. 1, there is provided an integrated part 19, in which three components from FIG. 1, namely the EGR valve 14, the charge air throttle 17 and the recirculation point 12, are combined constructionally. The three components are represented schematically by three triangles, denoted by the letters E, E, A, E meaning inlet in each case and A outlet. The exhaust gas-side inlet E and the fresh air-side inlet E are throttle points which control, on the one hand, the throughput of recirculated exhaust gas and, on the other, the throughput of fresh air. In a first variant, the adjustability may be effected jointly or dependently on one another, or, in a second variant, independently of one another. In the case of independent adjustability, a wider control range for the total system can be achieved.

FIG. 3 shows a second modification of the LP EGR system according to FIG. 1, with an integrated part 20 which comprises, firstly, the components according to part 19 in FIG. 2 (EGR valve, charge air throttle, recirculation point) and additionally an integrated air filter 18′. Four components are therefore constructionally combined in the part 20, simplifying installation and reducing installation space.

FIG. 4 shows the LP EGR system in a third modification, that is, with an integrated part 21 which comprises an integrated condensate separator 15′, additionally to the components of the part 19 in FIG. 2. Four components are therefore integrated in the part 21. The air filter 18 is arranged separately in this representation.

FIG. 5 shows a fourth modification of the LP EGR system according to FIG. 1, with an integrated part 22 which comprises an integrated condensate separator 15′ and an integrated air filter 18′ in addition to the part 19 according to FIG. 1; the integrated part 22 therefore contains five components integrated with one another.

FIG. 6 shows a fifth modification of the LP EGR system, with an integrated part 23 which comprises an integrated exhaust gas cooler 13′, an integrated condensate separator 15′ and an integrated air filter 18′ in addition to the part 19 according to FIG. 2. The integrated part 23 therefore contains six components integrated with one another.

FIG. 7 shows a sixth modification of the LP EGR system according to FIG. 1, with an integrated part 24 which comprises an integrated charge air compressor 8′, a condensate separator 15′ and an integrated air filter 18′ in addition to the integrated part 19 according to FIG. 1. The integrated part 24 therefore consists of six integrated components, or of the part 22 according to FIG. 5, in which the compressor 8′ has been additionally integrated. A high degree of integration is therefore likewise achieved, combined with installation space and cost reduction.

1. An arrangement for recirculating and cooling exhaust gas of an internal combustion engine, in particular of a diesel engine in a motor vehicle, the internal combustion engine having an exhaust gas line with an exhaust gas turbine and an intake line with a charge air compressor driven by the exhaust gas turbine, an extraction point for branching off an exhaust gas recirculation line (EGR line) being arranged downstream of the turbine and a recirculation point for return connection of the EGR line being arranged upstream of the compressor, and at least one exhaust gas heat exchanger and an EGR valve being arranged in the EGR line, wherein a charge air throttle element is arranged in the intake line and in the EGR valve, the recirculation point and the throttle element are formed as an integrated part.

2. The arrangement as claimed in claim 1, wherein the part has an exhaust gas-side inlet E and a fresh air-side inlet E which are adjustable with respect to their flow-through cross section.

3. The arrangement as claimed in claim 2, wherein the inlets E are adjustable independently of one another.

4. The arrangement as claimed in claim 2, wherein the inlets E are adjustable dependently on one another.

5. The arrangement as claimed in claim 1, wherein an air filter is arranged in the intake line and the air filter can be integrated additionally in the part.

6. The arrangement as claimed in claim 1, wherein a condensate separator is arranged in the EGR line and the condensate separator can be integrated additionally in the part.

7. The arrangement as claimed in claim 1, wherein the exhaust gas heat exchanger can be integrated additionally in the part.

8. The arrangement as claimed in claim 1, wherein the compressor can be integrated additionally in the part.
